(19) United States
(12) Patent Application Publication
(10) Pub. No.: US 2015/0096976 A1
(43) Pub. Date: Apr. 9, 2015

(54) MICROWAVABLE FOOD CONTAINER WITH AT LEAST ONE REMOVABLE MICROWAVE-INTERACTIVE ROBE

(71) Applicant: ConAgra Foods RDM, Inc., Omaha, NE (US)

(72) Inventor: David William France, Minneapolis, MN (US)

(73) Assignee: ConAgra Foods RDM, Inc., Omaha, NE (US)

(21) Appl. No.: 14/049,359

(22) Filed: Oct. 9, 2013

(51) Int. Cl. H05B 6/64; B65D 81/34

(52) U.S. Cl. CPC H05B 6/6408; B65D 81/3453
USPC 219/729; 219/730

(57) ABSTRACT

A microwavable food container includes a liquid-impermeable barrier configured with a single compartment or multiple compartments. The microwavable food container also includes at least one removable robe attached to the liquid-impermeable barrier on the outside surface of the container wall of one or more of the compartments. The removable robe includes a carrier and a microwave-interactive material applied to the carrier. If multiple robes are utilized, they can have similar microwave-interactive properties or different microwave-interactive properties to cause different heating environments within the container. Further, multiple microwave-interactive materials can be included on a single robe. The multiple-interactive materials can also have similar microwave-interactive properties or different microwave-interactive properties to cause different heating environments within the container.

### BACKGROUND

Microwavable food containers are typically formed using plastic molding techniques, such as thermoforming and injection molding.

### SUMMARY

A microwavable food container includes a liquid-impermeable barrier configured with a single compartment or multiple compartments. The microwavable food container also includes at least one removable robe attached to the liquid-impermeable barrier on the outside surface of the container wall of one or more of the compartments. The removable robe includes a carrier and a microwave-interactive material applied to the carrier. If multiple robes are utilized, they can have similar microwave-interactive properties or different microwave-interactive properties to cause different heating environments within the container. Further, multiple microwave-interactive materials can be included on a single robe. The multiple-interactive materials can also have similar microwave-interactive properties or different microwave-interactive properties to cause different heating environments within the container.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### DRAWINGS

The Detailed Description is described with reference to the accompanying figures. The use of the same reference numbers in different instances in the description and the figures can indicate similar or identical items.

FIG. 1 is an exploded isometric view illustrating a microwavable food container including a liquid-impermeable barrier and one or more removable robes for mechanically coupling to an outside surface of the liquid-impermeable barrier in accordance with example embodiments of the present disclosure.

FIG. 2A is a front elevation view illustrating a removable robe for a microwavable food container in accordance with an example embodiment of the present disclosure, where the removable robe is shown in a flat configuration.

FIG. 2B is an isometric view of the removable robe illustrated in FIG. 2A, where the removable robe is shown in a rolled configuration.

FIG. 3 is an exploded isometric view of a microwavable food container including a liquid-impermeable barrier and a removable robe, such as the removable robe illustrated in FIGS. 2A and 2B, mechanically coupled to an outside surface of the liquid-impermeable barrier in accordance with an example embodiment of the present disclosure.

FIG. 4A is an isometric view of the microwavable food container illustrated in FIG. 3.

FIG. 4B is a cross-sectional front elevation view of the microwavable food container illustrated in FIG. 3.

FIG. 5 is an exploded bottom plan view illustrating a microwavable food container including a liquid-impermeable barrier and multiple removable robes for selectively attaching to an outside surface of the liquid-impermeable barrier in accordance with an example embodiment of the present disclosure, where one of the multiple removable robes can be selected for a particular arrangement of food components.

FIG. 6A is an isometric view of a microwavable food container including a liquid-impermeable barrier and a removable robe mechanically coupled to an inside surface of the liquid-impermeable barrier in accordance with an example embodiment of the present disclosure.

FIG. 6B is a cross-sectional front elevation view of the microwavable food container illustrated in FIG. 6A.

FIG. 7 is a front elevation view illustrating a removable robe for a microwavable food container in accordance with an example embodiment of the present disclosure, where the removable robe is shown in a flat configuration and includes a tongue for engaging a corresponding slot.

FIG. 8 is an isometric view of a partially assembled microwavable food container including a liquid-impermeable barrier and a removable robe, such as the removable robe illustrated in FIG. 7, mechanically coupled to an outside surface of the liquid-impermeable barrier in accordance with an example embodiment of the present disclosure.

FIG. 9 is a front elevation view illustrating a removable robe for a microwavable food container in accordance with an example embodiment of the present disclosure, where the removable robe is shown in a flat configuration and includes an adhesive.

FIG. 10 is a front elevation view illustrating a removable robe for a microwavable food container in accordance with an example embodiment of the present disclosure, where the removable robe is shown in a flat configuration and includes multiple slots configured to mate with corresponding tabs on a liquid-impermeable barrier.

FIG. 11A is an isometric view of a microwavable food container including a liquid-impermeable barrier and a removable robe, such as the removable robe illustrated in FIG. 10, mechanically coupled to an outside surface of the liquid-impermeable barrier in accordance with an example embodiment of the present disclosure.

FIG. 11B is a cross-sectional front elevation view of the microwavable food container illustrated in FIG. 11A.

FIG. 12 is a cross-sectional front elevation view illustrating a microwavable food container including a liquid-impermeable barrier and a removable robe mechanically coupled to an outside surface of the liquid-impermeable barrier in accordance with an example embodiment of the present disclosure.

FIG. 13 is a flow diagram illustrating a method of forming a microwavable food container in accordance with example embodiments of the present disclosure.

### DETAILED DESCRIPTION

Aspects of the disclosure are described more fully hereinafter with reference to the accompanying drawings, which form a part hereof, and which show, by way of illustration, example features. The features can, however, be embodied in many different forms and should not be construed as limited to the combinations set forth herein; rather, these combinations are provided so that this disclosure will be thorough and complete, and will fully convey the scope. Among other things, the features of the disclosure can be facilitated by methods, devices, and/or embodied in articles of commerce. The following detailed description is, therefore, not to be taken in a limiting sense.

Microwavable food containers are typically formed using plastic molding techniques, such as thermoforming and injection molding. In many cases, it is also desirable to provide microwavable food containers with structures that shield food from microwave energy and/or focus microwave energy to particular foods in a container. For example, foil elements can be inserted into an injection mold to form an injection molded plastic container with an integral shield. However, this process is comparatively slow, machinery intensive, and costly when compared with typical high speed injection molding. Further, readily available high speed injection molding equipment is not generally compatible with this technique. In some instances, in-mold labeling is used to incorporate microwave-interactive elements into high speed injection molded or thermoformed parts, but the label materials used in these processes have limited mechanical properties and must be carefully matched with the equipment. Further, in-mold label materials are not generally compatible with microwave shielding or susceptor substrates, and in-mold labeling equipment is capital intensive and generally slower than typical injection molding or thermoforming equipment.

Accordingly, microwavable food containers and techniques of forming microwavable food containers are described that allow microwave-interactive structures to be selectively added to a microwavable food tray or cup without requiring the structures to be built into the manufacture of the base tray or cup. For example, microwave shielding structures, focusing structures, susceptor structures, and the like, are added to food trays or cups formed using traditional forming techniques, such as high speed injection molding, thermoforming, and so forth. Further, as described herein, one or more microwave-interactive structures can be selectively applied to a base structure at various times during a manufacturing process. In this manner, the base structure can remain generic until the container is filled with the final product (and possibly after filling has been accomplished and the package has been sealed). In embodiments, the finished package structure can be separated and easily recycled by the consumer after use. For example, a paperboard sleeve mechanically attached to a food tray is separated from the tray by the consumer after use and recycled using the consumer's normal recycling infrastructure (e.g., as opposed to in-mold label systems, where a metallic shielding element built into a label is incompatible with normal recycling procedures).

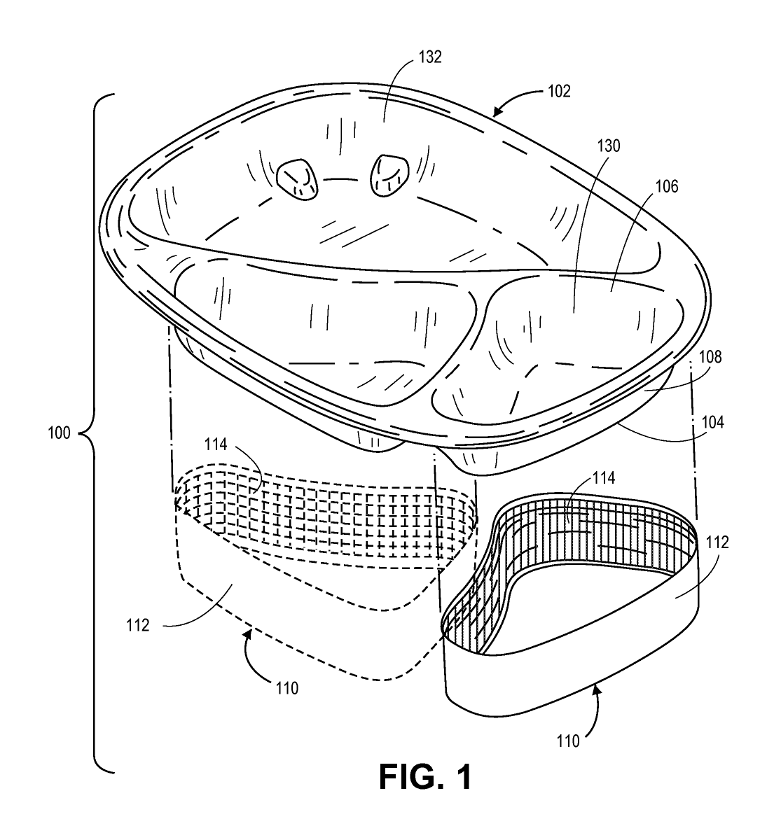

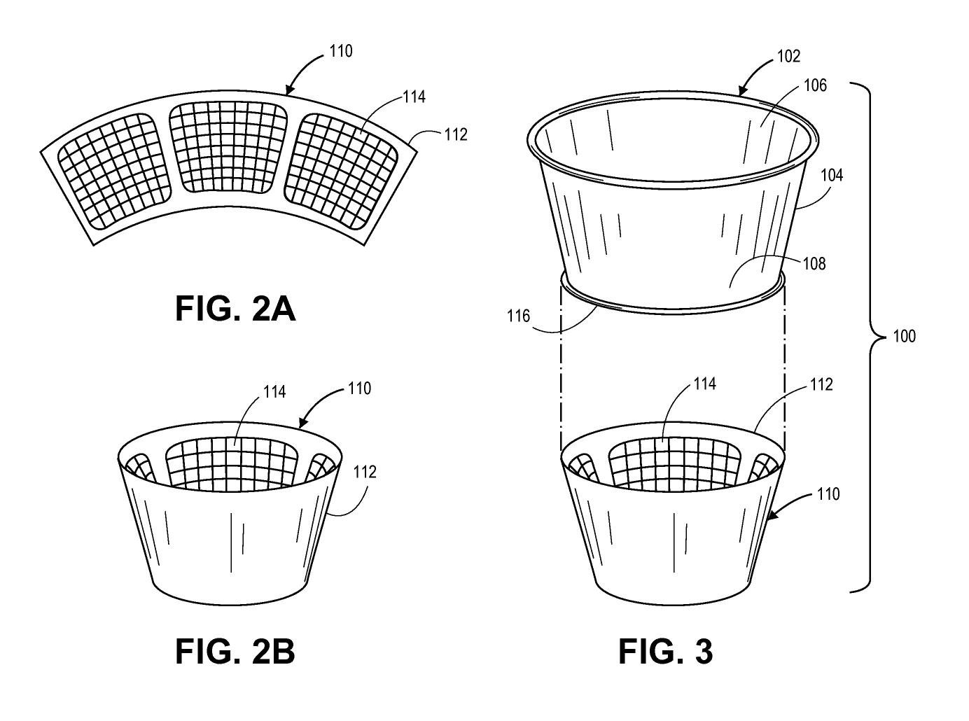

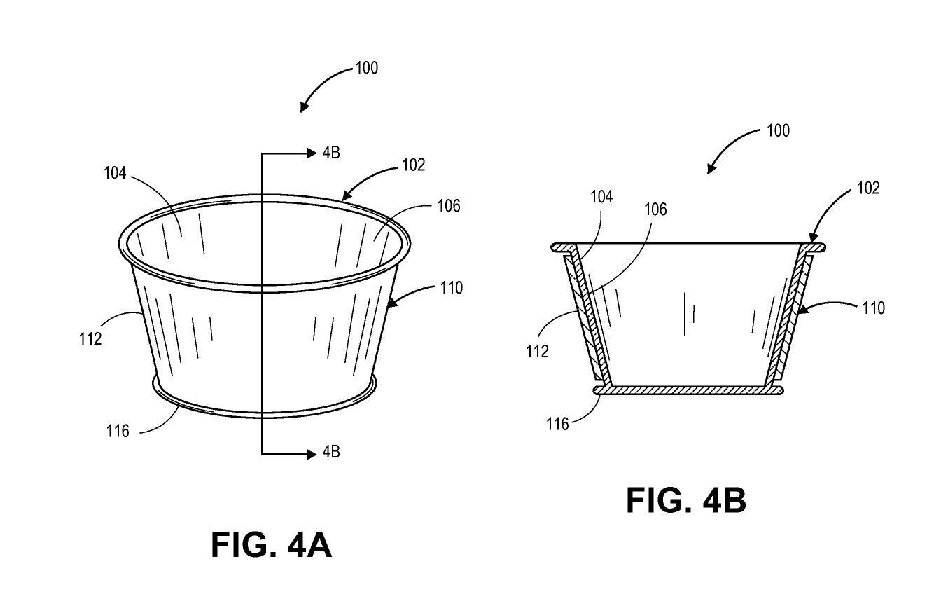

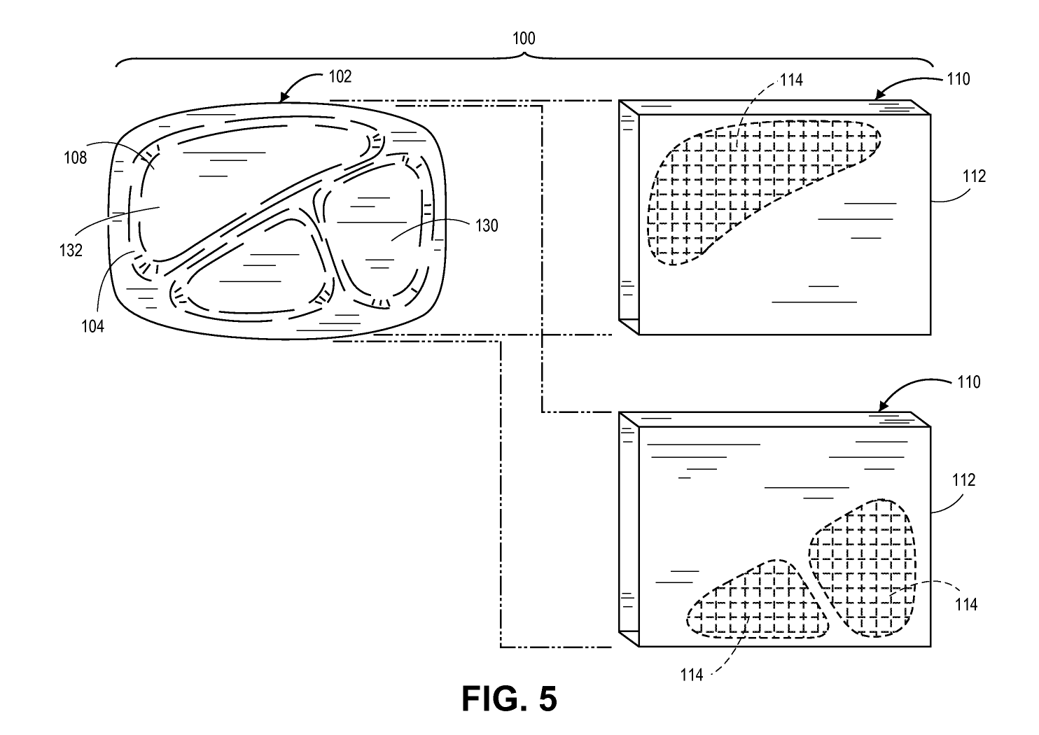

FIGS. 1 through 12 illustrate example microwavable food containers 100. The microwavable food containers 100 include a liquid-impermeable barrier 102. In some embodiments, the liquid-impermeable barrier 102 is formed as a multi-compartment food tray (e.g., as shown in FIGS. 1 and 5). In other embodiments, the liquid-impermeable barrier 102 is formed as a single compartment food cup (e.g., as shown in FIGS. 2 through 4, and 6 through 12). The liquid-impermeable barrier 102 is configured to retain liquid-based foods and prevent liquid from leaking and/or seeping through the barrier formed by the tray or cup. For example, the liquid-impermeable barrier 102 is formed from a material such as crystalline polyethylene terephthalate (CPET), polyethylene terephthalate (PET), a plastic polymer material, a paperboard based structure, a molded fiber based structure, and so forth. In embodiments of the disclosure, the liquid-impermeable barrier 102 does not include gussets in sealed areas, which could otherwise allow liquid to permeate the barrier (e.g., in the manner of a pressed paper tray).

The liquid-impermeable barrier 102 has a container wall 104 comprising an inner surface 106 configured to be in contact with a food component and an outside surface 108 opposite the inner surface 106. A removable robe 110 is attached to the liquid-impermeable barrier 102 on the container wall 104. The removable robe 110 comprises a carrier 112 and a microwave-interactive material 114 applied to the carrier 112 (e.g., in the manner of a microwave shield, a microwave antenna, and so on). For instance, the carrier 112 comprises a paper-based carrier (e.g., a paper film and/or a paperboard substrate), a plastic polymer carrier, and so forth, and the microwave-interactive material 114 comprises a foil pattern laminated to the carrier 112 and/or cold stamped and over-lacquered with a coating. However, these application techniques are provided by way of example only and are not meant to limit the present disclosure. In other embodiments, the microwave-interactive material 114 is applied to the carrier 112 using another technique, such as metallic ink printing. In further embodiments, the microwave-interactive material 114 comprises a polymer substrate laminated to foil, which is then applied to the carrier 112. In some embodiments, the microwave-interactive material 114 is patterned and/or shaped. Additionally, the microwave-interactive material 114 can be applied in multiple layers.

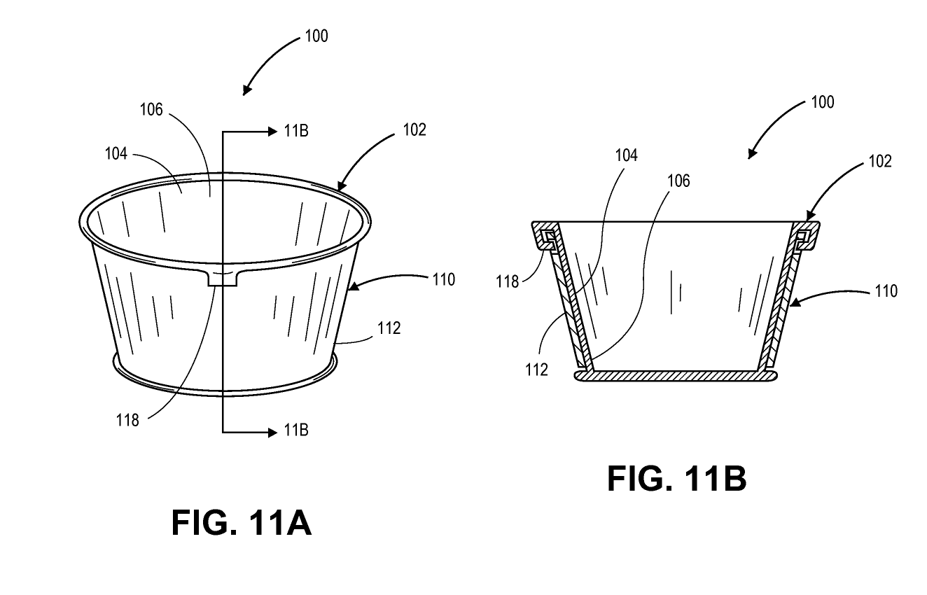

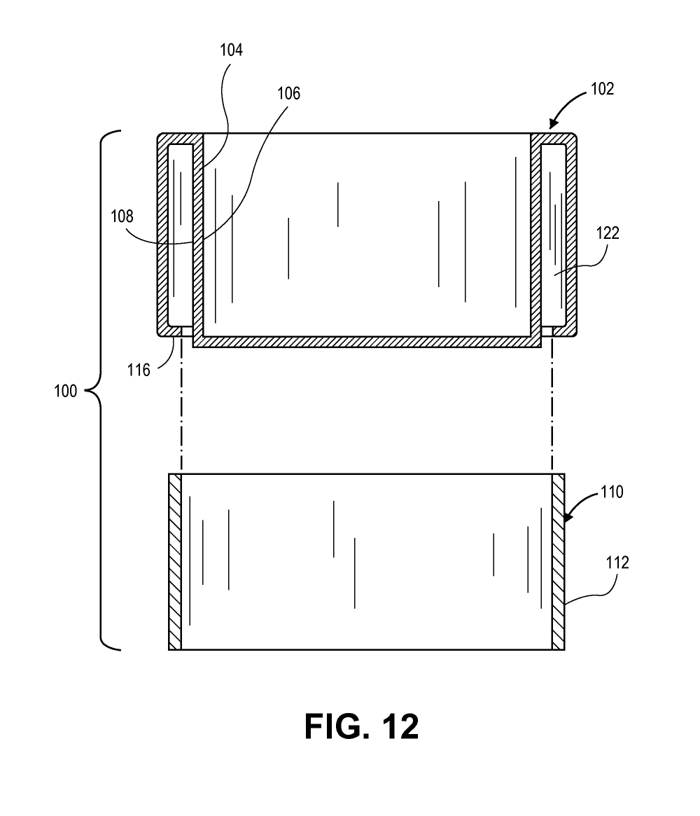

In embodiments of the disclosure, the removable robe 110 is attached on the outside surface 108 of the container wall 104. In some embodiments, the removable robe 110 is mechanically coupled to the outside surface 108 of the container wall 104. As shown in FIGS. 2A through 4B, a removable robe 110 is formed and slid onto a container wall 104 past a retention feature (e.g., a friction fit retention area or a retention bump 116) formed on the liquid-impermeable barrier 102, providing a snap fit which serves to hold the removable robe 110 in place with respect to the liquid-impermeable barrier 102. As shown in FIGS. 10 through 11B, a retention feature formed on the liquid-impermeable barrier 102 is implemented as one or more tabs 118, and corresponding slots 120 are formed on the removable robe 110, providing a snap fit which serves to hold the removable robe 110 in place with respect to the liquid-impermeable barrier 102. As shown in FIG. 12, a retention bump 116 is formed on the liquid-impermeable barrier 102, and the removable robe 110 is inserted into a slot 122 in the liquid-impermeable barrier 102, which serves to hold the removable robe 110 in place with respect to the liquid-impermeable barrier 102.

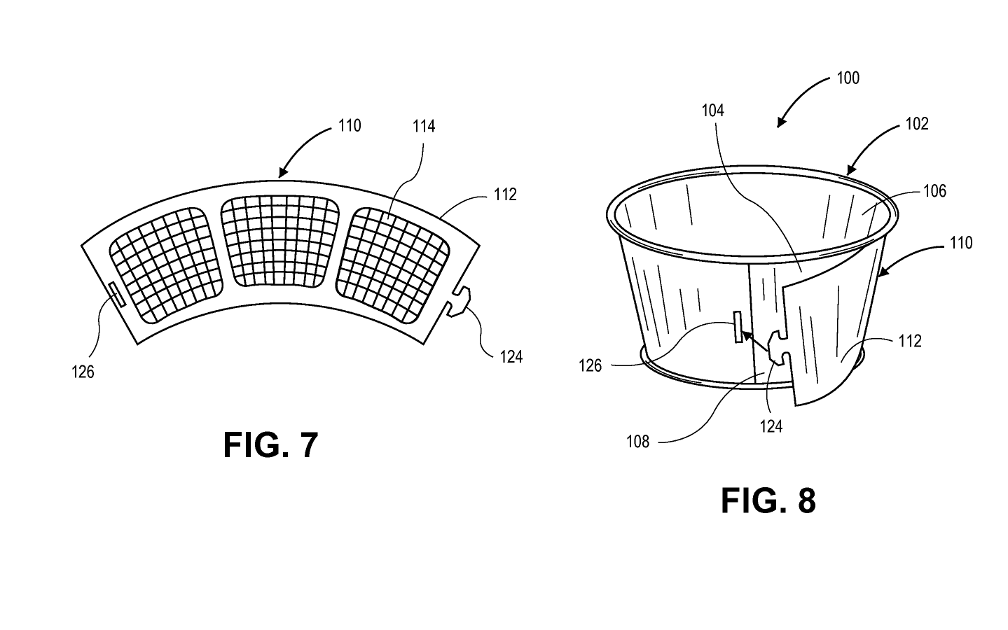

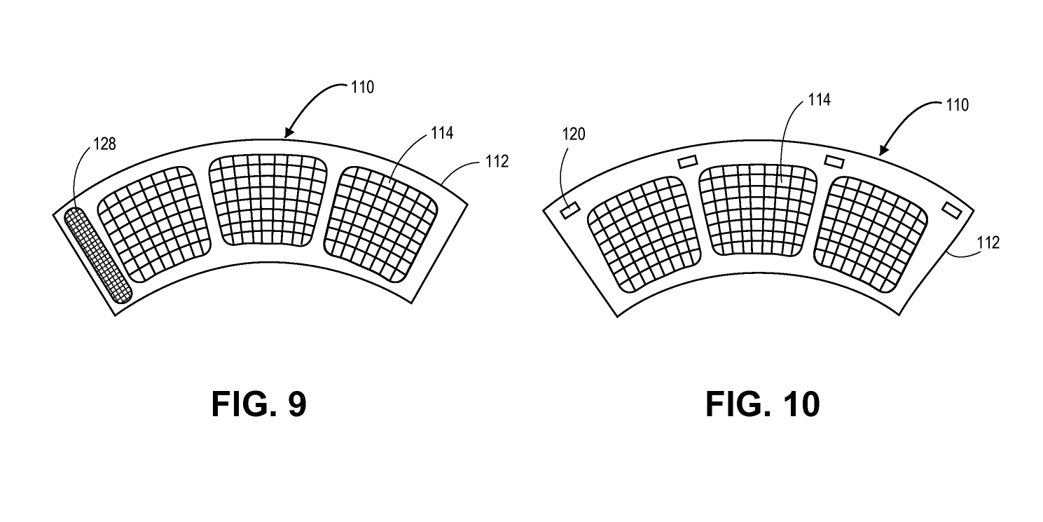

As shown in FIGS. 7 and 8, mechanical coupling can also be implemented by the removable robe 110. For example, the carrier 112 includes a tongue-in-slot configuration, where a tongue 124 engages a slot 126, serving to hold the removable robe 110 in place with respect to the liquid-impermeable barrier 102. With reference to FIG. 9, the carrier 112 can also be configured as a self-adhesive band. For instance, the carrier 112 includes an adhesive 128. It should be noted that the configurations shown in FIGS. 7 through 9 can also be implemented in combination with a retention feature formed on the liquid-impermeable barrier 102 (e.g., retention bump 116).

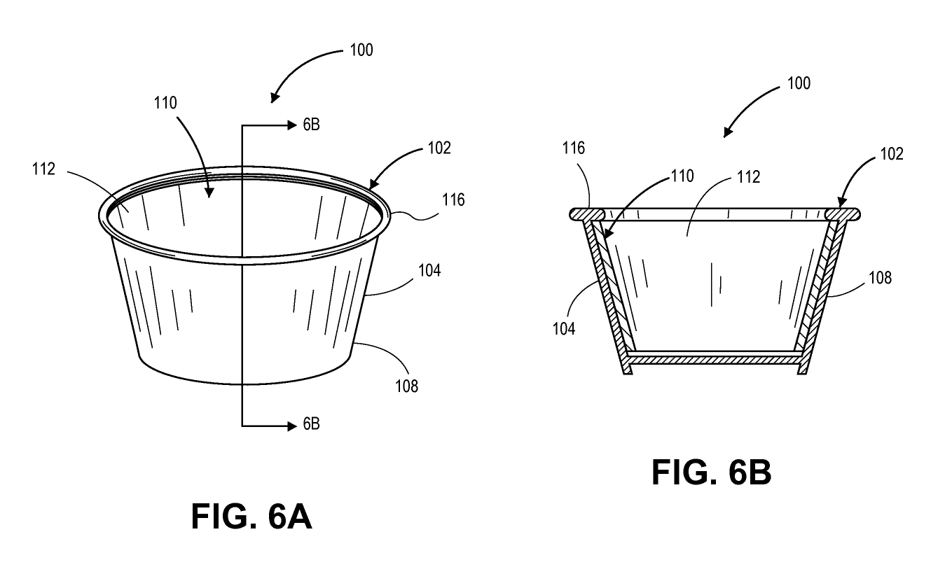

In other embodiments, the removable robe 110 is attached on the inner surface 106 of the container wall 104. In some embodiments, the removable robe 110 is mechanically coupled to the inner surface 106 of the container wall 104. As shown in FIGS. 6A and 6B, a removable robe 110 is formed and slid into a liquid-impermeable barrier 102 past a retention bump 116, providing a snap fit which serves to hold the removable robe 110 in place with respect to the liquid-impermeable barrier 102. In this configuration, the removable robe 110 can include a microwave-interactive material 114 formed as a susceptor, and the removable robe 110 may be in direct contact with a food component.

In some embodiments, the liquid impermeable barrier comprises a first compartment 130 configured to contain a first food component and a second compartment 132 configured to contain a second food component. The first compartment 130 and the second compartment 132 are configured to separate the first food component from the second food component. In some embodiments, the removable robe 110 is attached to the first compartment 130 and not the second compartment 132. In other embodiments, the removable robe 110 is attached to the first compartment 130 and the second compartment 132 (and possibly additional compartments as well). As previously discussed, the removable robe 110 can be mechanically attached to one or more of the first compartment 130 and the second compartment 132 (e.g., using a retention feature, such as the retention bump 116). Further, the removable robe 110 can be glued to the liquid-impermeable barrier 102.

In some embodiments, multiple removable robes 110 are attached to the liquid-impermeable barrier 102. For example, two removable robes 110 are separately attached to a liquid-impermeable barrier 102 (e.g., as shown in FIG. 1). The two removable robes 110 can have similar microwave-interactive properties. For example, both removable robes 110 are implemented using microwave shield structures having the same or substantially similar shielding properties. In other embodiments, the removable robes 110 have different microwave-interactive properties (e.g., to cause the same or different heating environments within the microwavable food container 100). For example, one removable robe 110 attached to a liquid-impermeable barrier 102 has a microwave-interactive material 114 comprising a microwave shield structure, and another removable robe 110 attached to the liquid-impermeable barrier 102 has a microwave-interactive material 114 comprising a microwave focusing structure. In another example, one removable robe 110 attached to a liquid-impermeable barrier 102 has a microwave-interactive material 114 comprising a microwave antenna structure with a first characteristic reception value, and another removable robe 110 attached to the liquid-impermeable barrier 102 has a microwave-interactive material 114 comprising a microwave antenna structure with a second characteristic reception value (e.g., different from the first characteristic reception value).

Further, in some embodiments, one or more removable robes 110, each having multiple microwave-interactive materials 114, are attached to the liquid-impermeable barrier 102. For example, one removable robe 110 having two microwave-interactive materials 114 is attached to a liquid-impermeable barrier 102 (e.g., as shown in FIG. 5). The two microwave-interactive materials 114 can have similar microwave-interactive properties. For example, both microwave-interactive materials 114 are implemented using microwave shield structures having the same or substantially similar shielding properties. In other embodiments, the microwave-interactive materials 114 have different microwave-interactive properties (e.g., to cause the same or different heating environments within the microwavable food container 100). For example, one microwave-interactive material 114 comprises a microwave shield structure, and another microwave-interactive material 114 comprises a microwave focusing structure. In another example, one microwave-interactive material 114 comprises a microwave antenna structure with a first characteristic reception value, and another microwave-interactive material 114 comprises a microwave antenna structure with a second characteristic reception value (e.g., different from the first characteristic reception value).

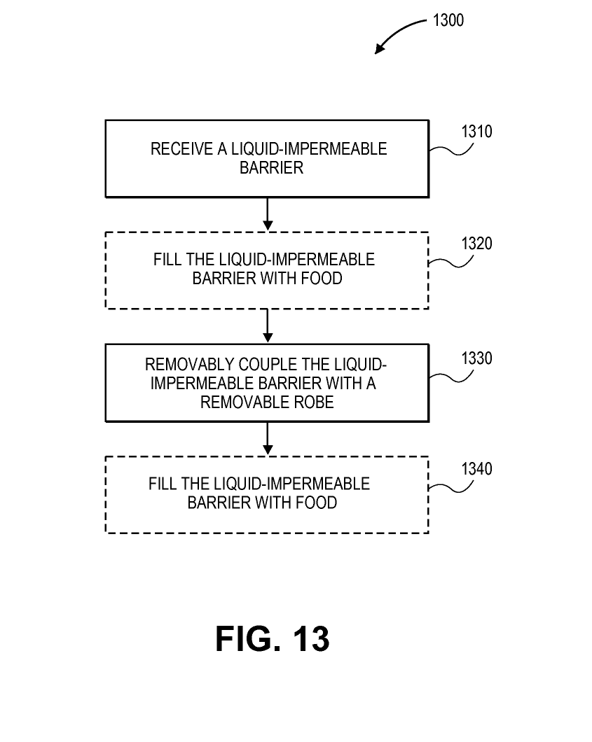

FIG. 13 illustrates a procedure 1300, in an example embodiment, in which a microwavable food container that includes a liquid-impermeable barrier and a removable robe is formed. A liquid-impermeable barrier comprising a container wall having an inner surface configured to be in contact with a food component and an outside surface opposite the inner surface is received (Block 1310). For example, with reference to FIGS. 1 through 12, liquid-impermeable barrier 102 comprising a food tray or cup is received. In some embodiments, the liquid-impermeable barrier is then filled with food (Block 1320). For instance, with reference to FIGS. 1 through 12, first compartment 130 and/or second compartment 132 of the liquid-impermeable barrier 102 are filled with food, and the food tray is sealed (or one or more of a number of compartments is sealed).

Then, the liquid-impermeable barrier is removably coupled with a removable robe, where the removable robe includes a carrier and a microwave-interactive material applied to the carrier (Block 1330). For example, with reference to FIGS. 1 through 12, removable robe 110 is mechanically coupled to the liquid-impermeable barrier 102. However, in other embodiments, the liquid-impermeable barrier is filled with food after the liquid-impermeable barrier is removably coupled with the removable robe (Block 1340). For example, with reference to FIGS. 1 through 12, the first compartment 130 and/or the second compartment 132 of the liquid-impermeable barrier 102 are filled with food after the removable robe 110 is mechanically coupled to the liquid-impermeable barrier 102, and the food tray is then sealed (or one or more of a number of compartments is sealed).

In still further embodiments, one or more compartments of the liquid-impermeable barrier are filled with food before the liquid-impermeable barrier is removably coupled with the removable robe, and one or more additional compartments of the liquid-impermeable barrier are filled with food after the liquid-impermeable barrier is removably coupled with the removable robe. For example, with reference to FIGS. 1 through 12, the first compartment 130 of the liquid-impermeable barrier 102 is filled with food before the removable robe 110 is mechanically coupled to the liquid-impermeable barrier 102, the second compartment 132 is filled with food after the removable robe 110 is mechanically coupled to the liquid-impermeable barrier 102, and the food tray is then sealed. It should also be noted that the removable robe 110 can be attached to the liquid-impermeable barrier 102 while the liquid-impermeable barrier 102 is filled with food.

In this manner, the removable robe 110 can be applied after the liquid-impermeable barrier 102 is formed. For example, application of the removable robe 110 can be performed in line after thermoforming and prior to trimming and stacking bulk containers. Further, the removable robe 110 can be applied at a filling line as the liquid-impermeable barrier 102 is filled with food product and sealed. Additionally, as shown in FIG. 5, different removable robes 110 can be provided for different food component configurations, to selectively shield one or more food components that are separately positioned within a food tray. Additionally, multiple removable robes 110 having the same, similar, and/or different combinations of microwave-interactive materials 114 can be used to selectively shield separate compartments of a liquid-impermeable barrier 102. For example, a delicate component, such as a dessert, can be shielded within a prepackaged meal. In this manner, a dessert compartment in a frozen meal can be kept cold, while other compartments are heated normally within a microwave oven, providing, for instance, a hot entrée with vegetables, and a cold dessert. It should also be noted that the techniques described herein can be used in combination with lid films and/or closure systems to provide additional shielding and/or focusing functionality.

As described, the containers and techniques disclosed herein are used to provide food manufacturers with flexible and economic platforms for preparing prepackaged microwavable foods. For example, a generic base food tray is manufactured in bulk and used for multiple stock keeping units (SKUs) by a manufacturer who produces several different microwavable meal types. The same type of food tray is filled for various SKUs (e.g., with different food components), while different removable robes are applied to the food trays depending upon a combination of food components in a food tray, an arrangement of food components within separate compartments of the food tray, cooking characteristics for different compartments of a food tray, and so forth. In this manner, the manufacturer does not require a specific type of food tray or cup for a particular SKU.

Although the subject matter has been described in language specific to structural features and/or process operations, it is to be understood that the subject matter defined in the appended claims is not necessarily limited to the specific features or acts described above. Rather, the specific features and acts described above are disclosed as example forms of implementing the claims.

1. A multi-compartment microwavable food container comprising:
a tray comprising a liquid-impermeable barrier comprising a first compartment configured to contain a first food component and a second compartment configured to contain a second food component, the first compartment and the second compartment configured to separate the first food component from the second food component, the first compartment and the second compartment arranged generally horizontally with respect to one another, the first compartment comprising a container wall having an inner surface configured to be in contact with the first food component and an outside surface opposite the inner surface; and
a removable robe mechanically coupled to the liquid-impermeable barrier on the outside surface of the container wall of the first compartment, the removable robe comprising a carrier and a microwave-interactive material applied to the carrier.

2. The multi-compartment microwavable food container as recited in claim 1, wherein the liquid-impermeable barrier comprises a retention feature for mechanically coupling the removable robe to the liquid-impermeable barrier.

3. The multi-compartment microwavable food container as recited in claim 1, wherein a second removable robe is mechanically coupled to the liquid-impermeable barrier on the outside surface of a container wall of the second compartment.

4. The multi-compartment microwavable food container as recited in claim 3, wherein microwave-interactive properties of the second removable robe are different from microwave-interactive properties of the removable robe.

5. The multi-compartment microwavable food container as recited in claim 1, wherein the microwave-interactive material comprises at least one of a microwave shield structure, a microwave antenna structure, a microwave focusing structure, or a susceptor structure.

6. A method of forming a microwavable food container comprising:
receiving a liquid-impermeable barrier comprising a container wall having an inner surface configured to be in contact with a food component and an outside surface opposite the inner surface;
removably coupling the liquid-impermeable barrier with a removable robe attached to the liquid-impermeable barrier on the outside surface of the container wall, the removable robe comprising a carrier and a microwave-interactive material applied to the carrier; and
retaining the removable robe by the liquid-impermeable barrier after removably coupling the removable robe with the liquid-impermeable barrier.

7. The method as recited in claim 6, wherein the liquid-impermeable barrier is filled with the food component prior to removably coupling the liquid-impermeable barrier with the removable robe.

8. The method as recited in claim 6, wherein the removable robe is mechanically coupled to the liquid-impermeable barrier.

9. The method as recited in claim 8, wherein the liquid-impermeable barrier comprises a retention feature for mechanically coupling the removable robe to the liquid-impermeable barrier.

10. The method as recited in claim 6, wherein the liquid impermeable barrier comprises a first compartment configured to contain a first food component and a second compartment configured to contain a second food component, the first compartment and the second compartment configured to separate the first food component from the second food component, and the removable robe is attached to the first compartment.

11. The method as recited in claim 10, wherein a second removable robe is attached to the second compartment.

12. The method as recited in claim 11, wherein microwave-interactive properties of the second removable robe are different from microwave-interactive properties of the removable robe.

13. The method as recited in claim 6, wherein the microwave-interactive material comprises at least one of a microwave shield structure, a microwave antenna structure, a microwave focusing structure, or a susceptor structure.

14. A microwavable food container comprising:
a liquid-impermeable barrier comprising a container wall having an inner surface configured to be in contact with a food component and an outside surface opposite the inner surface; and
a removable robe attached to the liquid-impermeable barrier on the outside surface of the container wall, the removable robe comprising a carrier and a microwave-interactive material applied to the carrier, the carrier comprising a tongue and a slot, wherein the tongue is configured to engage the slot to hold the carrier in place with respect to the liquid-impermeable barrier.

15. (canceled)

16. (canceled)

17. The microwavable food container as recited in claim 14, wherein the liquid impermeable barrier comprises a first compartment configured to contain a first food component and a second compartment configured to contain a second food component, the first compartment and the second compartment configured to separate the first food component from the second food component, and the removable robe is attached to the first compartment.

18. The microwavable food container as recited in claim 17, wherein a second removable robe is attached to the second compartment.

19. The microwavable food container as recited in claim 18, wherein microwave-interactive properties of the second removable robe are different from microwave-interactive properties of the removable robe.

20. The microwavable food container as recited in claim 14, wherein the microwave-interactive material comprises at least one of a microwave shield structure, a microwave antenna structure, a microwave focusing structure, or a susceptor structure.
